(19) United States
(12) Patent Application Publication
(10) Pub. No.: US 2016/0173265 A1
(43) Pub. Date: Jun. 16, 2016

(54) DETECTING UPLINK/DOWNLINK TIME-DIVISION DUPLEXED (TDD) FRAME CONFIGURATIONS TO SYNCHRONIZE TDD DOWNLINK AND UPLINK COMMUNICATIONS BETWEEN TDD COMMUNICATIONS EQUIPMENT

(71) Applicant: Corning Optical Communications Wireless Ltd, Airport City (IL)

(72) Inventors: Daniel Dadoun, Rehovot (IL); Guy Lupescu, Tel Aviv (IL)

(21) Appl. No.: 15/049,663

(22) Filed: Feb. 22, 2016

Related U.S. Application Data
(63) Continuation of application No. PCT/IL14/50758, filed on Aug. 25, 2014.
(60) Provisional application No. 61/871,573, filed on Aug. 29, 2013.

(51) Int. Cl. H04L 5/22; H04W 56/00; H04J 3/06; H04W 52/02; H04B 3/02; H04L 5/14; H04B 7/26

(52) U.S. Cl. CPC H04L 5/22; H04L 5/14; H04W 56/001; H04B 7/2656; H04W 52/0229; H04B 3/02; H04J 3/06

(57) ABSTRACT

Detecting uplink/downlink time-division duplexed (TDD) frame configurations in TDD communications signals to synchronize uplink communications from TDD communications units. In one example, embodiments disclosed herein involve detecting uplink/downlink time-division duplexed (TDD) frame configurations employed in downlink TDD communications signals transmitted from a TDD base station. The TDD base station may be configured to provide TDD communications according to a TDD frame to a distributed antenna system. The detected uplink/downlink TDD frame configuration of the downlink TDD communications signals can be used to determine time periods in the TDD frame when downlink communications transmissions are intended and uplink communications transmissions are intended. In this manner, a TDD distributed communications unit can synchronize transmission circuitry transmitting uplink TDD communications signals to the TDD base station in a different time slot(s) from reception of downlink TDD communication signals from the TDD base station to avoid or reduce data loss.

### RELATED APPLICATIONS

This application is a continuation of International Application No. PCT/IL14/050758 filed on Aug. 25, 2014 which claims the benefit of priority to U.S. Provisional Application No. 61/871,573, filed on Aug. 29, 2013, both applications being incorporated herein by reference.

### BACKGROUND

The disclosure relates generally to time-division duplexed (TDD) communications equipment configured to communicate TDD communications signals over a common communications medium and more particularly to detecting TDD frame configurations in TDD communications signals which may be used in synchronizing downlink and uplink communications between TDD communications equipment.

No admission is made that any reference cited herein constitutes prior art. Applicant reserves the right to challenge the accuracy and pertinency of any cited documents.

Wireless communications is rapidly growing, with ever-increasing demands for high-speed mobile data communication. As an example, local area wireless services (e.g., so-called “wireless fidelity” or “WiFi” systems) and wide area wireless services are being deployed in many different types of areas (e.g., coffee shops, airports, libraries, etc.). TDD communications is one type of wireless communications that is being employed for high-speed mobile communications. Known examples of TDD include Digital Enhanced Cordless Telecommunications (DECT) wireless telephony, and TD-code Division Multiple Access (CDMA) (TD-CDMA). TDD refers to providing duplex communications links whereby downlink communications signals are separated from uplink communications signals by the allocation of different time slots in the same frequency band. TDD allows both downlink and uplink communications transmissions to share the same transmission/communications medium. More specifically, TDD involves dividing a data stream into data frames and assigning different time slots to downlink and uplink communications transmissions. Users in a TDD distributed antenna system are allocated time slots for downlink transmissions and uplink transmissions. TDD also advantageously allows for asymmetric assignment and flow for uplink and downlink data transmissions in TDD data frames to provide for asymmetric (i.e., different) capacities or data rates between downlink communications and uplink communications depending on traffic and throughput considerations.

TDD can be employed in distributed antenna systems (referred to as “TDD distributed antenna systems”) to separate downlink communications signals from uplink communications signals by matching full duplex communications over a half-duplex communications link. TDD distributed communications or antenna systems communicate with TDD wireless devices called “clients,” “client devices,” or “wireless client devices,” which must reside within the wireless range or “cell coverage area” in order to communicate with an access point device. TDD distributed antenna systems are particularly useful to be deployed inside buildings or other indoor environments where TDD client devices may not otherwise be able to effectively receive radio-frequency (RF) signals from a source, such as a base station for example. Exemplary applications wherein TDD distributed antenna systems can be used to provide or enhance coverage for wireless services include public safety, cellular telephony, wireless local access networks (LANs), location tracking, and medical telemetry inside buildings and over campuses.

One approach to deploying a TDD distributed antenna system involves the use of RF antenna coverage areas, also referred to as “antenna coverage areas.” Antenna coverage areas can be formed by remotely distributed antenna units, also referred to as remote units (RUs). The remote units each contain or are configured to couple to one or more antennas configured to support the desired frequency(ies) or polarization to provide the antenna coverage areas. Antenna coverage areas can have a radius in the range from a few meters up to twenty meters as an example. Combining a number of remote units creates an array of antenna coverage areas. Because the antenna coverage areas each cover small areas, there typically may be only a few users (clients) per antenna coverage area. This arrangement generates a uniform high quality signal enabling high throughput supporting the required capacity for the wireless system users.

In TDD distributed antenna systems where data is transferred in sequential synchronized radio frames, one method is required to determine periods when downlink communications signals are being transmitted in a given time slot in a TDD frame and when uplink communications signals are being transmitted in a given time slot in the TDD frame. Transmitter and receiver circuits in such a TDD distributed antenna system must be synchronized to these downlink communications signal and uplink communications signal periods so that downlink communications signals are not transmitted when uplink communications signals are present on the communications medium. In other words: the radio frame structure is known to TDD communications devices in the TDD distributed antenna system. Such TDD communications devices know when uplink communications messages can be sent and when uplink communications messages should not be sent to receive downlink communications signals. Otherwise, data losses can occur when downlink communications signals are not received when uplink communications signals are being transmitted. “Back-off” collision detection and avoidance systems can be employed to wait for a defined period of time until the communications medium is clear of uplink communications signals before asserting new downlink communications signals on the communications medium. However, throughput would be reduced to half-duplex as a result. Collision detection and management mechanisms may also add design complexity, thereby increasing cost by requiring additional components, and requiring additional area on electronic boards.

### SUMMARY

Embodiments disclosed herein include detecting uplink/downlink time-division duplexed (TDD) frame configurations in TDD communications signals to synchronize downlink and uplink communications between TDD communications units. Related systems and methods are also disclosed herein. More specifically, as one non-limiting example, embodiments disclosed herein involve detecting uplink/downlink TDD frame configurations in downlink TDD communications signals from a TDD base station. The TDD base station may be configured to provide TDD communications according to a TDD frame to a distributed antenna system to be distributed remotely to TDD client devices. The detected uplink/downlink TDD frame configuration in the downlink TDD communications signals can be used to determine the time periods or slots in the TDD frame when downlink communications transmissions are intended and uplink communications transmissions are intended. In this manner, TDD communications units in the distributed antenna system can synchronize transmission circuitry transmitting uplink TDD communications signals in a different time period(s) or slot(s) from reception of downlink TDD communications signals from the TDD base station to avoid or reduce data loss.

Detecting uplink/downlink TDD frame configuration to synchronize TDD communications between TDD base stations and TDD communications units in distributed antenna systems can be advantageously employed where the TDD communications do not include markers or other indicia that guarantees the exclusive start of a downlink communications time period or uplink communications time period. Avoiding data loss in TDD communications is desired, because TDD provides duplex communications links, whereby downlink communications signals are separated from uplink communications signals by the allocation of different time slots in the same frequency band over a shared communications medium.

One embodiment of the disclosure relates to a TDD communications unit is provided. The TDD communications unit comprises a TDD communications signal interface. The TDD communications signal interface is configured to receive a downlink TDD communications signal and an uplink TDD communications signal over a communications medium. The TDD communications unit also comprises an uplink transmitter circuit coupled to the TDD communications signal interface. The uplink transmitter circuit is configured to transmit the uplink TDD communications signal over the communications medium during at least one uplink frame period of a TDD frame based on a received uplink transmission control signal. The TDD communications unit also comprises a downlink receiver circuit coupled to the TDD communications signal interface. The downlink receiver circuit is configured to be deactivated to not sample the downlink TDD communications signal during at least one uplink frame period of the TDD frame based on a received downlink reception control signal. The TDD communications unit also comprises a controller. The controller is configured to detect an uplink/downlink TDD frame configuration of the TDD frame. The controller is also configured to determine at least one uplink frame period in the TDD frame based on the detected uplink/downlink TDD frame configuration. The controller is also configured to generate the uplink transmission control signal based on the determined at least one uplink frame period in the TDD frame. The controller is also configured to generate the downlink reception control signal based on the determined at least one uplink frame period in the TDD frame.

An additional embodiment of the disclosure relates to a method for synchronizing TDD downlink and uplink communications with a TDD communications unit is provided. The method comprises receiving a downlink TDD communications signal having a TDD frame. The method also comprises detecting an uplink/downlink TDD frame configuration of the TDD frame. The method also comprises determining at least one uplink frame period in the TDD frame based on the detected uplink/downlink TDD frame configuration. The method also comprises generating an uplink transmission control signal based on the determined at least one uplink frame period in the TDD frame. The method also comprises generating a downlink reception control signal based on the determined at least one uplink frame period in the TDD frame. The method also comprises transmitting the uplink TDD communications signal from an uplink transmitter circuit over the communications medium during the at least one uplink frame period in the TDD frame based on receiving the uplink transmission control signal. The method also comprises deactivating a downlink receiver circuit to not sample the downlink TDD communications signal during at least one uplink frame period of the TDD frame based on receiving the downlink reception control signal.

An additional embodiment of the disclosure relates to a TDD distributed antenna system is provided. The TDD distributed antenna system comprises a head-end unit. The head-end unit comprises a first TDD communications signal interface configured to receive a downlink TDD communications signal over a communications medium from a base station and distribute the downlink communications signal to a plurality of remote units. The head-end unit also comprises a second TDD communications interface configured to receive an uplink TDD communications signal from the plurality of remote units and distribute the received uplink TDD communications signal to the base station. The head-end unit also comprises an uplink transmitter circuit coupled to the first TDD communications signal interface. The uplink transmitter circuit is configured to transmit the received uplink TDD communications signal from at least one distributed antenna system communications medium communicatively coupling a plurality of remote units to the head-end unit, over the communications medium to the base station during at least one uplink frame period of a TDD frame based on a received uplink transmission control signal. The head-end unit also comprises a downlink receiver circuit coupled to the first TDD communications signal interface. The downlink receiver circuit is configured to be deactivated to not sample the downlink TDD communications signal during at least one uplink frame period of the TDD frame based on a received downlink reception control signal. The head-end unit also comprises a controller. The controller is configured to detect an uplink/downlink TDD frame configuration of the TDD frame. The controller is also configured to determine at least one uplink frame period in the TDD frame based on the detected uplink/downlink TDD frame configuration. The controller is also configured to generate the uplink transmission control signal based on the determined at least one uplink frame period in the TDD frame. The controller is also configured to generate the downlink reception control signal based on the determined at least one uplink frame period in the TDD frame.

Further, the TDD distributed antenna system also comprises each of the plurality of remote units. Each of the plurality of remote units comprises at least one antenna configured to receive the uplink TDD communications signal from at least one TDD client device. Each of the plurality of remote units also comprises an uplink transmitter circuit configured to transmit the uplink TDD communications signal over the at least one distributed antenna system communications interface to the head-end unit during at least one uplink frame period of a TDD frame, based on a received uplink transmission control signal from the head-end unit. Each of the plurality of remote units also comprises a downlink receiver circuit configured to be deactivated to not sample the downlink TDD communications signal received from the head-end unit over the at least one distributed antenna system communications medium during the at least one uplink frame period of the TDD frame, based on a received downlink reception control signal from the head-end unit.

Additional features and advantages will be set forth in the detailed description which follows, and in part will be readily apparent to those skilled in the art from the description or recognized by practicing the embodiments as described in the written description and claims hereof, as well as the appended drawings. The foregoing general description and the following detailed description are merely exemplary. The accompanying drawings are included to provide a further understanding, and are incorporated in and constitute a part of this specification.

### BRIEF DESCRIPTION OF THE DRAWINGS

FIG. 1 is a schematic diagram of an exemplary point to multi-point TDD distributed antenna system (DAS) employing TDD communications units in the form of a DAS central unit configured to detect uplink/downlink TDD frame configurations in TDD communications signals from a TDD base station and synchronize uplink communications transmissions from the TDD communications units to the TDD base station;

FIG. 2 is a schematic diagram of the exemplary TDD DAS in FIG. 1 provided in an indoor building and configured to distribute synchronized TDD communications services to different floors of the building;

FIG. 3 is an exemplary diagram of detecting an uplink/downlink TDD frame configuration in TDD communications signals in the TDD DAS in FIG. 1, to synchronize uplink TDD communications transmissions from TDD communications units to the TDD base station;

FIG. 4 is a schematic diagram illustrating exemplary detail of components that can be provided in the TDD communications unit in the TDD DAS of FIG. 1 to detect an uplink/downlink TDD frame configuration in TDD communications signals from a TDD base station and synchronize uplink TDD communications transmissions from TDD communications units in the TDD DAS to the TDD base station based on the detected uplink/downlink TDD frame configuration;

FIG. 5A is a flowchart illustrating an exemplary process for detecting an uplink/downlink TDD frame configuration in TDD communications signals from the TDD base station in the TDD DAS in FIG. 1;

FIG. 5B is a flowchart illustrating an exemplary process for synchronizing uplink TDD communications transmissions from the TDD communications units in the TDD DAS to the TDD base station based on the detected uplink/downlink TDD frame configuration in FIG. 5A;

FIG. 5C is a state machine diagram illustrating an exemplary state machine process for transmitting uplink TDD communications signals during uplink frame periods of the TDD frame and receiving downlink TDD communications signals during downlink frame periods of the TDD frame;

FIG. 6 is a schematic diagram of an exemplary Long Term Evolution (LTE) TDD frame having a specific uplink/downlink TDD frame configuration;

FIG. 7 is a table illustrating different uplink/downlink LTE TDD frame configurations that can be detected to synchronize LTE TDD uplink communications transmissions from TDD communications units to the TDD base station in a LTE TDD DAS based on the detected LTE TDD frame configuration;

FIG. 8 is a flowchart illustrating an exemplary process for detecting uplink/downlink LTE TDD frame configuration in LTE TDD communications signals from a LTE TDD base station that can be employed in the process illustrated in FIG. 5A and for synchronizing LTE TDD uplink communications transmissions from LTE TDD communications units to a LTE TDD base station in a LTE TDD DAS based on the detected LTE TDD frame configuration that can be performed in the process of FIG. 5B; and

FIG. 9 is a schematic diagram of an exemplary computer system that can be included in or interface with any of the TDD communications equipment described herein.

### DETAILED DESCRIPTION

Reference will now be made in detail to the embodiments, examples of which are illustrated in the drawings, in which some, but not all embodiments are shown. The concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed herein include detecting uplink/downlink time-division duplexed (TDD) frame configurations in TDD communications signals to synchronize downlink and uplink communications between TDD communications units. Related systems and methods are also disclosed herein. More specifically, as one non-limiting example, embodiments disclosed herein involve detecting uplink/downlink TDD frame configurations in downlink TDD communications signals from a TDD base station. The TDD base station may be configured to provide TDD communications according to a TDD frame to a distributed antenna system to be distributed remotely to TDD client devices. The detected uplink/downlink TDD frame configuration in the downlink TDD communications signals can be used to determine the time periods or slots in the TDD frame when downlink communications transmissions are intended and uplink communications transmissions are intended. In this manner, TDD communications units in the distributed antenna system (DAS) can synchronize transmission circuitry transmitting uplink TDD communications signals in a different time period(s) or slot(s) from reception of downlink TDD communications signals from the TDD base station to avoid or reduce data loss.

Detecting uplink/downlink TDD frame configuration to synchronize TDD communications between TDD base stations and TDD communications units in DASs can be advantageously employed where the TDD communications do not include markers or other indicia that guarantees the exclusive start of a downlink communications time period or uplink communications time period. Avoiding data loss in TDD communications is desired, because TDD provides duplex communications links, whereby downlink communications signals are separated from uplink communications signals by the allocation of different time slots in the same frequency band over a shared communications medium.

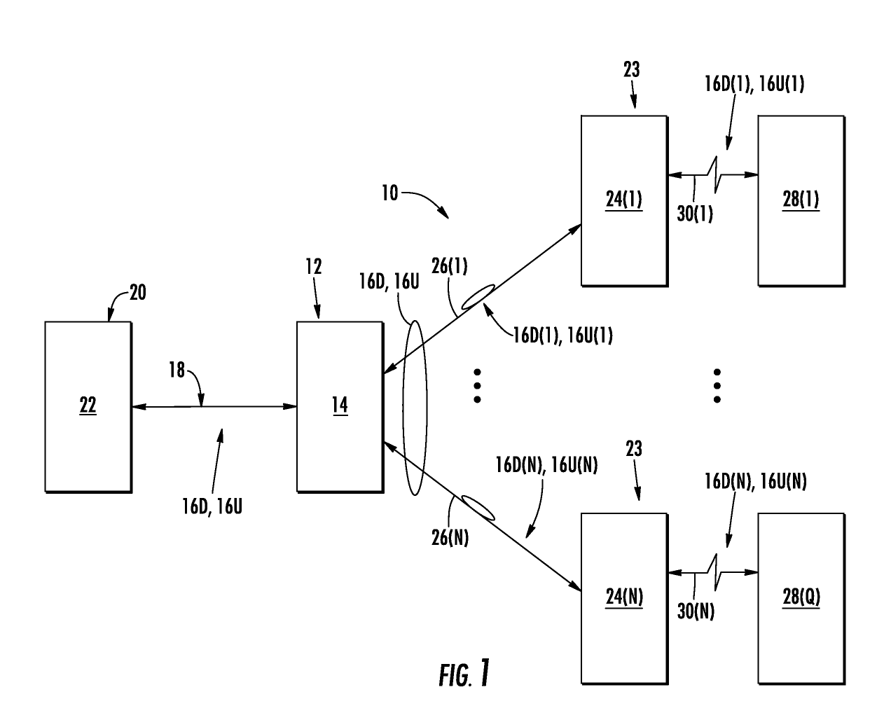

Before discussing examples of detecting uplink/downlink TDD frame configurations in TDD communications signals to synchronize uplink communications from TDD communications units in a distributed antenna system, exemplary TDD communications units are first described with regard to FIG. 1. In this regard, FIG. 1 is a schematic diagram of exemplary TDD communications units configured to communicate TDD communications signals over a common communications medium where it is desired to avoid data loss. FIG. 1 illustrates an example of a DAS 10 as a non-limiting example of a system that includes TDD communications units in this embodiment. The DAS is thus also referred to herein as a “TDD DAS 10.” The TDD DAS 10 includes first TDD communications unit 12 in the form of a central unit 14. The central unit 14 may also be referred to as a head-end unit (HEU) or head-end equipment (HEE). The central unit 14 could also be a TDD communications repeater as another example. The central unit 14 is configured to receive downlink TDD communications signals 16D over a communications medium 18 from second TDD communications units 20 in the form of a TDD base station 22. The central unit 14 distributes the received downlink TDD communications signals 16D to one or more of a plurality of remote units 24(1)-24(N) in the TDD DAS 10 in a point-to-multipoint configuration in this example. The central unit 14 is coupled to third TDD communications units 23 provided in the form of a plurality remote units 24(1)-24(N) with a dedicated communications medium 26(1)-26(N) in a point-to-multipoint configuration.

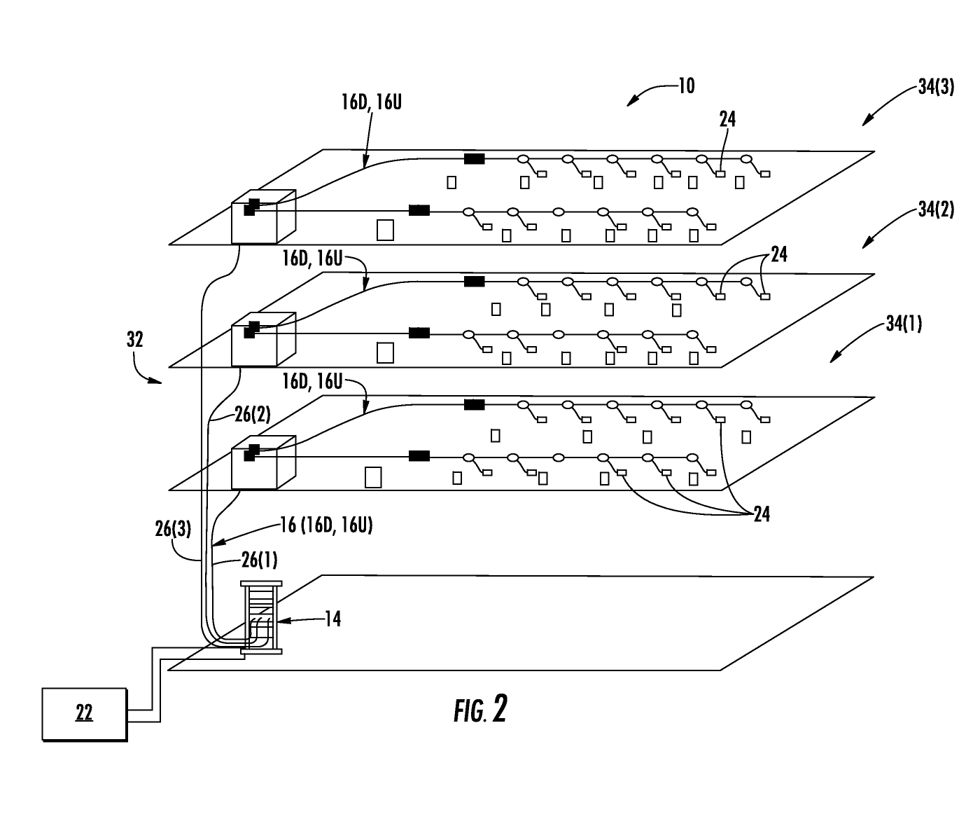

The central unit 14 is also configured to receive uplink TDD communications signals 16U from the remote units 24(1)-24(N). The remote units 24(1)-24(N) are remote antenna units in this embodiment that can wirelessly receive the uplink TDD communications signals 16U from one or more client devices 28(1)-28(Q). The client devices 28(1)-28(Q) and the remote units 24(1)-24(N) may be configured to communicate wirelessly with each other, or over physical communications links 30(1)-30(N), or both. The central unit 14 transmits the received uplink TDD communications signals 16U from the remote units 24(1)-24(N) over the communications medium 18 to the TDD base station 22. The TDD DAS 10 may be provided in an outdoor or an indoor environment. For example, FIG. 2 is a schematic diagram of the TDD DAS 10 in FIG. 1 provided in an indoor building 32 configured to distribute TDD communications services to different floors 34(1), 34(2), 34(3) of the building 32 over communications media 26(1)-26(3).

With continuing reference to FIGS. 1 and 2, the communications medium 18 communicatively coupling the central unit 14 to the TDD base station 22 in FIG. 1 is a common communications medium in this example. In other words, the communications medium 18 carries both the downlink TDD communications signals 16D and the uplink TDD communications signals 16U between the TDD base station 22 and the central unit 14. As a non-limiting example, the communications medium 18 may be an electrical coaxial cable, twisted pair wiring (e.g., CAT5/6/7), or other communications medium. To avoid data loss of downlink TDD communications signals 16D, the communications medium 18 is provided with a TDD duplex communications link. The downlink TDD communications signals 16D are separated from the uplink TDD communications signals 16U by the allocation of different time slots in the same frequency band. If the downlink TDD communications signals 16D and the uplink TDD communications signals 16U were communicated in the same time slots over the communications medium 18, data loss of the downlink TDD communications signals 16D would occur. The TDD communications units, namely the central unit 14 and the remote units 24(1)-24(N), may transmit uplink TDD communications signals 161J when downlink TDD communications signals 16D are being communicated to these units. Thus, it is desired to provide for the central unit 14 and remote units 24(1)-24(N) to not transmit the uplink TDD communications signals 16U in a time slot in which the downlink TDD communications signals 16D are being transmitted by the TDD base station 22. However, the protocol of the particular TDD communications services may not include a marker or other indicia in a TDD communications frame that provides a known, guaranteed transition between a downlink communications period and an uplink communications period. One example of such a TDD communications service is Long Term Evolution (LTE) TDD. The central unit 14 in FIG. 1 needs to have the capability of controlling transmission of the uplink TDD communications signals 16U in time periods of a TDD communications frame only when the downlink TDD communications signals 16D are not being transmitted on the communications medium 18.

In this regard, as will be described in more detail below, in embodiments disclosed herein, the central unit 14 in the TDD DAS 10 is configured to detect an uplink/downlink TDD frame configuration of the TDD frame by using the TDD base station 22 to control timing of transmission of downlink TDD communications signals 16D to the central unit 14. The detected uplink/downlink TDD frame configuration of the TDD frame is used by the central unit 14 to synchronize transmission of uplink TDD communications signals 16U over the communications medium 18 with reception of downlink TDD communications signals 16D over the communications medium 18 from the TDD base station 22. The central unit 14 synchronizes transmission of uplink TDD communications signals 161U by the central unit 14 and the remote units 24(1)-24(N) to not be communicated at the same time that the TDD base station 22 is transmitting downlink TDD communications signals 16D over the communications medium 18 to the central unit 14 and distributed to the remote units 24(1)-24(N). In this manner, data loss in the downlink TDD communications signals 16D is reduced or avoided. The uplink/downlink TDD frame configuration of the downlink TDD communications signals 16D is detected, because the TDD communications protocol of the downlink TDD communications signals 16D may not include a marker or other indicia that guarantees the exclusive start of a downlink communications time period or uplink communications time period in a TDD communications frame.

An uplink/downlink TDD frame configuration is the configuration of uplink and downlink time slots of a TDD communications frame (referred to as “TDD frame”). The TDD frame provides the timing protocol for TDD communications. The time slots in the TDD frame designated as uplink time slots are time slots where uplink TDD signals or data are designated to be communicated over a communications medium in the absence of downlink TDD signals or data. The time slots in the TDD frame designated as downlink time slots are time slots where downlink TDD signals or data are designated to be communicated over a communications medium in the absence of uplink TDD signals or data. In this manner, two TDD communications devices communicating TDD communications signals to each other can ensure that downlink TDD communications signals and uplink TDD signals are not communicated in the communications medium in the same time slot.

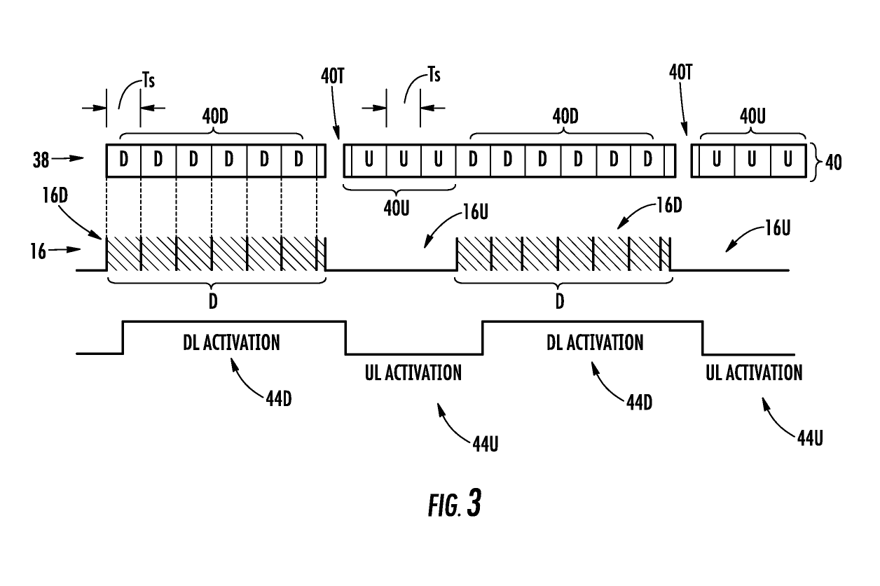

For example, FIG. 3 is an exemplary diagram of detecting an uplink/downlink TDD frame configuration of a TDD frame used to control transmission timing of TDD communications signals in the TDD DAS 10 in FIG. 1. An exemplary TDD frame 38 for controlling transmission of TDD communications signals is shown in FIG. 3. The TDD frame 38 is comprised of time or frame periods 40, each of a duration Ts. The frame periods 40 are configured to either be downlink frame periods 40D or uplink frame periods 40U according to the TDD frame 38 configuration. The downlink frame periods 40D are designated as times when downlink communication data D can be communicated. The uplink frame periods 40U are designated as times when uplink communication data U can be communicated. The particular arrangement of the frame periods 40 provides the uplink/downlink TDD frame configuration of the TDD frame 38. In this manner, the TDD frame 38 provides for downlink communication data D and uplink communication data U to be communicated over the same communications medium (such as communications medium 18 in FIG. 1) at the same frequency without data loss. Transition frame periods 40T may also be included in the TDD frame 38 that contain special data or information and provide a transition from a downlink frame period 40D to an uplink frame period 40U.

With continuing reference to FIG. 3, an actual TDD communications signal 16 constructed according to the TDD frame 38 is shown that can be transmitted by the TDD base station 22 in FIG. 1. The TDD communications signal 16 is comprised of the downlink communications signal 16D and the uplink TDD communications signal 16U. Only the downlink TDD communications signal 16D of the TDD communications signal 16 is shown as containing downlink communication data D in FIG. 3. The central unit 14 in FIG. 1 that receives the downlink communications signal 16D and is configured to distribute the uplink TDD communications signal 16U received from the remote units 24(1)-24(N), may not know the particular uplink/downlink TDD frame configuration of the TDD frame 38 when receiving downlink TDD communication signal 16D. There may be different uplink/downlink TDD frame configurations of the TDD frame 38 that provide different transmission timings of TDD signals according to the TDD protocol being employed.

Thus, in embodiments disclosed herein, with reference to FIG. 3 as an example, the central unit 14 (shown in FIG. 1) can detect an uplink/downlink TDD frame configuration of the TDD frame used to control transmission of the downlink TDD communications signal 16D by the TDD base station 22. The central unit 14 can monitor the power of the downlink communications signal 16D on the communications medium 18 to detect the downlink TDD communications signal 16D. The central unit 14 can then detect uplink/downlink TDD frame configuration of the TDD frame 38 employed by the base station 22 for controlling the transmission timing of downlink TDD communications signal 16D according to pattern recognitions of the downlink and uplink time periods in the TDD frame 38 according to the TDD protocol known to be employed. The central unit 14 can detect transitions from downlink frame periods 40D to uplink frame periods 40U in the downlink TDD communications signal 16D by monitoring the power of the downlink TDD communications signal 16D on the communications medium 18 to determine the uplink/downlink TDD frame configuration of the TDD frame 38. In response, using the detected uplink/downlink TDD frame configuration of the TDD frame 38 employed by the base station 22, the central unit 14 can synchronize the downlink communications signal 16D reception and uplink TDD communications signal 16U transmissions from the remote units 24(1)-24(N) to the central unit 14 and from the central unit 14 to the TDD base station 22, based on the detected uplink/downlink TDD frame configuration of the TDD frame 38. More particularly as an example, the central unit 14 can activate downlink receiver circuitry in the central unit 14 and the remote units 24(1)-24(N) to receive the downlink TDD communications signal 16D over the communications medium 18 from the TDD base station 22 and the central unit 14, respectively, during downlink frame periods 40D during downlink (DL) activation periods 44D. The central unit 14 can also activate uplink transmitter circuitry in the central unit 14 and the remote units 24(1)-24(N) to transmit the uplink TDD communications signal 16U over the communications medium 18 to the TDD base station 22 and the central unit 14, respectively, during uplink frame periods 40U during uplink (UL) activation periods 44U. In this manner, data loss of the downlink TDD communications signals 16D is reduced or avoided.

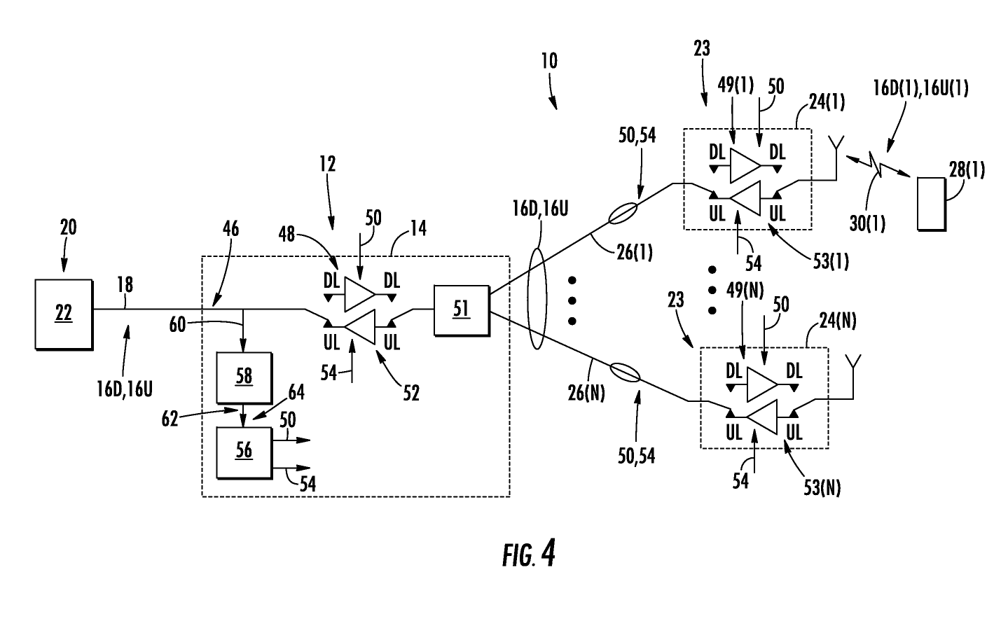

FIG. 4 is a schematic diagram illustrating exemplary components that may be provided in the central unit 14 of FIG. 1 to detect an uplink/downlink TDD frame configuration of a TDD frame employed by the TDD base station 22. As will be discussed below, the central unit 14 can use the detected uplink/downlink TDD frame configuration of the TDD frame to synchronize TDD uplink communications transmissions and TDD downlink communications receptions based on the detected TDD frame configuration of the TDD frame. For the example in FIG. 4, the TDD frame 38 in FIG. 3 will be referenced as the example of the TDD frame employed by the base station 22 to control transmission of the downlink TDD communications signal 16D.

In this example in FIG. 4, the downlink TDD communications signal 16D is received over the communications medium 18 by a TDD communications signal interface 46 in the central unit 14. A downlink receiver circuit 48 is provided in the central unit 14 and is coupled to the TDD communications signal interface 46. The downlink receiver circuit 48 is coupled to a communications interface 51 to transmit the downlink TDD communications signals 16D received from the TDD base station 22 to the remote units 24(1)-24(N). Downlink receiver circuits 49(1)-49(N) are also provided in the remote units 24(1)-24(N) to receive the downlink TDD communications signals 16D distributed by the central unit 14. As will be discussed in more detail below, the downlink receiver circuits 48, 49(1)-49(N) are configured to be activated to receive the downlink TDD communications signal 16D from the TDD base station 22 and the remote unit 14, respectively, during downlink frame periods 40D based on a received downlink reception control signal 50.

With continuing reference to FIG. 4, an uplink transmitter circuit 52 is also provided in the central unit 14 and is also coupled to the TDD communications signal interface 46. The uplink transmitter circuit 52 is configured to transmit the uplink TDD signal 16U over the communications medium 18 to the TDD base station 22 during uplink frame periods 40U of the downlink TDD signal 16D based on a received uplink transmission control signal 54. Uplink receiver circuits 53(1)-53(N) are also provided in the remote units 24(1)-24(N) to transmit the uplink TDD communications signal 16U to the central unit 14 during uplink frame periods 40U. The uplink receiver circuits 53(1)-53(N) are configured to transmit the uplink TDD communications signal 16U to the central unit 14 through the communications interface 51 during uplink frame periods 40U.

Thus in summary, in this embodiment in FIG. 4, the downlink receiver circuits 48, 49(1)-49(N) and the uplink transmitter circuits 52, 53(1)-53(N) are controllable to receive the downlink TDD communications signal 16D and transmit the uplink TDD communications signal 16U in different frame periods 40 of the TDD frame 38 according to the uplink/downlink TDD frame configuration of the TDD frame 38 to avoid data loss.

The downlink reception control signal 50 may be the same signal as the uplink transmission control signal 54, as opposed to being different signals. For example, an inverter gate may be included between the downlink reception control signal 50 and the downlink receiver circuit 48 in the central unit 14, so that the downlink reception control signal 50 and the uplink transmission control signal 54 have opposite signal levels indicating different states for activation and deactivation. Alternatively, the downlink receiver circuit 48 or the uplink transmitter circuit 52 in the central unit 14 may be configured to be activated on an opposite signal level from the uplink transmitter circuit 52 or the downlink receiver circuit 48, respectively.

With continuing reference to FIG. 4, the central unit 14 also contains a controller 56 in this embodiment. The controller 56 may be a processor, central processing unit (CPU), field programmable gate array (FPGA), or other circuit, as non-limiting examples. The controller 56 is configured to generate and provide the downlink reception control signal 50 and the uplink transmission control signal 54 based on synchronization with the frame periods 40 of the TDD frame 38 according to detected uplink/downlink TDD frame configuration of the TDD frame 38. In the example discussed below, uplink/downlink TDD frame configuration of the TDD frame 38 is determined based on transitions between the downlink TDD communications signal 16D and the uplink TDD communications signal 16U communicated over the communications medium 18.

With continuing reference to FIG. 4, in one embodiment as described in more detail below, to detect the uplink/downlink TDD frame configuration TDD frame, a power detector 58 may be provided in the central unit 14 in this embodiment. The power detector 58 comprises a power detector input 60 coupled to the communications medium 18. The power detector 58 is configured to generate a power detector output 62. The power detector output 62 is provided to a controller input 64 of the controller 56 to provide a representation of detected power in the downlink TDD communications signal 16D to the controller 56. The detected power enables the controller 56 to detect the uplink/downlink TDD frame 38 configuration of the downlink TDD communications signal 16D based on the power detector output 62, and synchronize the transmission of the uplink TDD communications signal 16U by the uplink transmitter circuit 52 in the central unit 14 and the uplink transmitter circuits 53(1)-53(N) in the remote units 24(1)-24(N) in the uplink frame periods 40U to avoid data loss of the downlink TDD communications signal 16D.

Note that the configuration of the uplink/downlink TDD frame configuration of the TDD frame 38 to be used for synchronizing uplink TDD signals 16U in the TDD DAS 10 can also be programmed in the central unit 14, such as in memory (not shown) provided in the central unit 14 and accessible by the controller 56. This is opposed to the controller 56 detecting the configuration of uplink/downlink TDD frame 38 from the downlink and uplink TDD signals 16D, 16U communicated over the communications medium 18. For example, a technician could configure or program the configuration of uplink/downlink TDD frame 38 for downlink and uplink TDD signals 16D, 16U based on knowledge of the base station 22 configuration, if known and/or if such uplink/downlink TDD frame 38 will remain the same during operations.

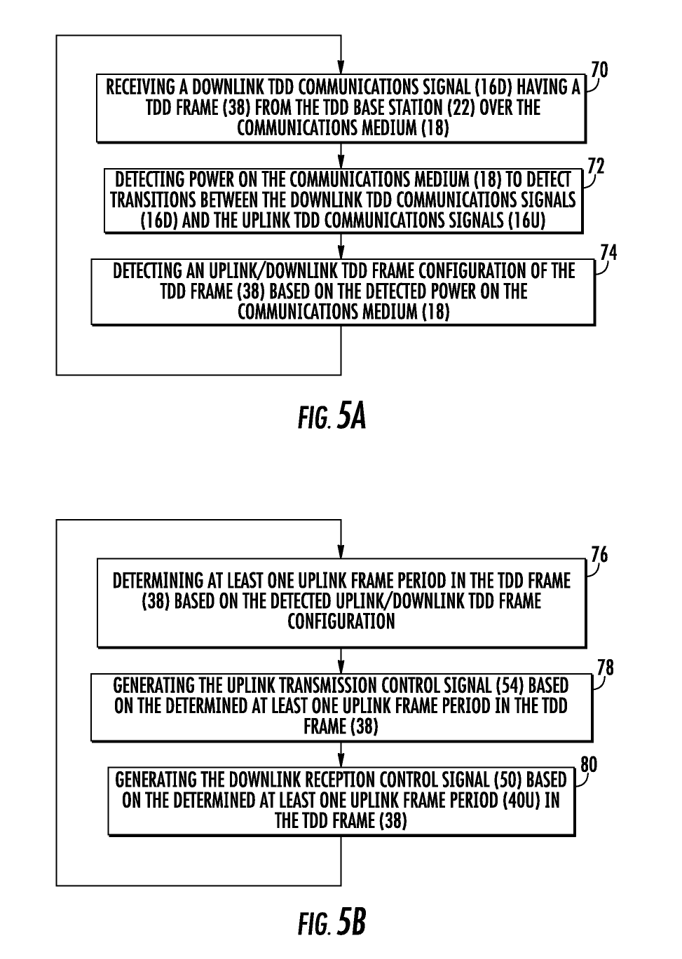

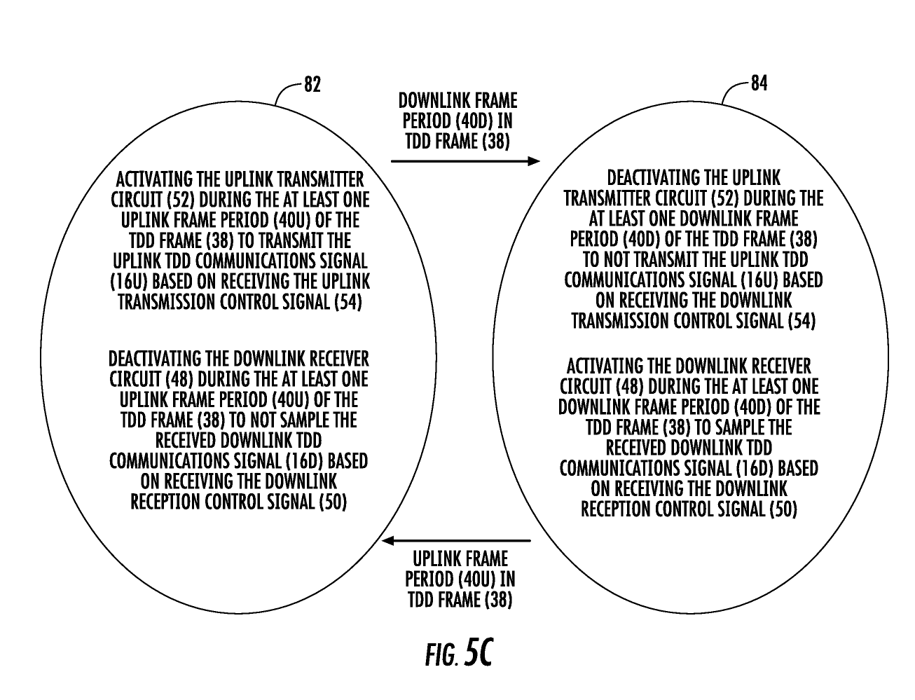

In this regard, FIG. 5A is a flowchart illustrating an exemplary process for the central unit 14 to detect the uplink/downlink TDD frame configuration of the TDD frame 38 used by the base station 22 to control transmission timing of the downlink TDD communications signals 16D from the TDD base station 22. FIG. SB is a flowchart illustrating an exemplary process for synchronizing uplink TDD communications signal 16U transmissions by TDD communications units in the TDD DAS 10. The exemplary processes in FIGS. SA and SB will be discussed with reference to the exemplary components of the central unit 14 in FIG. 4.

With reference to FIG. 5A, the central unit 14 receives the downlink TDD communications signal 16D over the communications medium 18 through the TDD communications signal interface 46 coupled to the communications medium 18 (block 70). If the configuration of uplink/downlink TDD frame 38 is not known by the central unit 14, the uplink/downlink TDD frame 38 configuration can be detected based on comparison to known uplink/downlink TDD frame configurations. This comparison to known uplink/downlink TDD frame configurations may be based on detection of power in the downlink and uplink TDD communications signals 16D, 16U communicated over the communications medium 18. In this regard, in this example, the downlink TDD communications signal 16D is coupled to the power detector input 60 of the power detector 58, as illustrated in FIG. 4. The power detector 58 detects the power of the downlink and uplink TDD communications signal 16D, 16U communicated over the communications medium 18 (block 72). The power detector 58 may include any type of power detection circuitry desired, and provide any representation of power desired, including without limitation voltage and/or current level. The power detector 58 provides detected power level on a power detector output 62 to the controller 56. If the configuration of the uplink/downlink TDD frame 38 is not programmed, the controller 56, as an option, uses the detected power level in the downlink and uplink TDD communications signals 16D, 16U communicated over the communications medium 18 to detect an uplink/downlink TDD frame 38 configuration of the downlink TDD communications signal 16D (block 74). Examples of detecting the uplink/downlink TDD frame 38 configuration based on detected power level are described in more detail below.

The uplink/downlink TDD frame 38 configuration detected in the process in FIG. 5A can be used to synchronize the transmission of the uplink TDD communications signals 16U and the reception of downlink TDD communications signals 16D in the TDD DAS 10. In this regard, FIG. SB is a flowchart illustrating an exemplary process for synchronizing uplink TDD communications signal 16U transmissions by TDD communications units in the TDD DAS 10. With reference to FIG. SB, the controller 56 determines the uplink frame period 40U in the TDD frame 38 based on the detected uplink/downlink TDD frame 38 configuration based on the power transitions between downlink TDD communications signals 16D and uplink TDD communications signals 16U on the communications medium 18 (block 76). In this manner, the controller 56 can use its knowledge of the uplink frame period(s) 40U in the TDD frame 38 to determine when to activate the uplink transmitter circuit 52 to transmit the uplink TDD communications signals 16U to the TDD base station 22 in synchronization with the uplink frame period(s) 40U such that the uplink TDD communications signals 16U are not transmitted when the downlink TDD communications signals 16D are being received. For example, the controller 56 may generate a timing pattern for the TDD frame 38 that can be used to synchronize the transmission of the uplink TDD signals 16U and the reception of the downlink TDD signals 16D.

A more specific, non-limiting process for determining the uplink frame period 40U in the downlink TDD communications signal 16D based on the detected uplink/downlink TDD frame 38 configuration of the downlink TDD communications signal 16D (block 76) may be as follows. Once the uplink/downlink TDD frame 38 configuration of the downlink TDD communications signal 16D has been detected (block 74), the controller 56 can detect transitions in power on the communications medium 18 from an uplink frame period 40U to a downlink frame period 40D in the downlink TDD communications signal 16D and vice versa. This allows the controller 56 to a create a TDD frame timing pattern by matching the detected uplink/downlink TDD frame 38 configuration with the actual timing transitions between downlink TDD communications signal 16D and uplink TDD communications signal 16U power to synchronize the generation of the uplink transmission control signal 54 within the uplink frame period 40U of the TDD frame 38. The controller 56 generates the uplink transmission control signal 54 in the uplink frame period 40U according to the TDD frame 38 timing pattern and a timing based from detected transitions of the uplink frame period 40U to a downlink frame period 40D on the communications medium 18 and vice versa.

With continuing reference to FIG. 5B, the controller 56 generates the uplink transmission control signal 54 based on the determined uplink frame period(s) 40U in the TDD frame 38 (block 78). The uplink transmitter circuits 52, 53(1)-53(N) in the central unit 14 and the remote units 24(1)-24(N), respectively, receive the uplink transmission control signal 54. During uplink frame periods 40U in the TDD frame 38, the uplink transmission control signal 54 causes the uplink transmitter circuits 52, 53(1)-53(N) to transmit the uplink TDD communications signals 16U to the TDD base station 22 and the central unit 14, respectively, as illustrated in uplink transmission process 82 in the state machine in FIG. 5C. In this manner, the uplink transmitter circuits 52, 53(1)-53(N) transmit the uplink TDD communications signals 16U in synchronization with the uplink frame period(s) 40U in the TDD frame 38 (block 80 in FIG. 5B). Also during the uplink frame periods 40U in the TDD frame 38, the controller 56 is configured to generate the downlink reception control signal 50 (block 80 in FIG. 5B) to cause the downlink receiver circuits 48, 49(1)-49(N) to be deactivated so as to not sample communications signals (process 82 in FIG. 5C) during the uplink frame periods 40U in the TDD frame 38. This is so that the downlink receiver circuits 48, 49(1)-49(N) are not activated to receive downlink TDD communications signals 16D during the uplink frame period(s) 40D in the TDD frame 38 when uplink TDD communication signals 16U are being transmitted (process 84 in FIG. 5C).

The controller 56 may optionally be configured to generate the uplink transmission control signal 54 just prior to and in anticipation of the start of the uplink frame period 40U in the TDD frame 38 (e.g., a few microseconds prior). In this manner, the controller 56 can compensate for propagation delay between the generation of the uplink transmission control signal 54 and activation of the uplink transmitter circuits 52, 53(1)-53(N) in response to receipt of the uplink transmission control signal 54 so that data communications rates are not reduced as a result of the delay. Also, the controller 56 may optionally be configured to generate the downlink reception control signal 50 just prior to and in anticipation of the start of the downlink frame period 40D in the TDD frame 38 (e.g., a few microseconds prior). In this manner, the controller 56 can compensate for propagation delay between the generation of the downlink transmission control signal 50 and activation of the downlink transmitter circuits 48, 49(1)-49(N) in response to receipt of the downlink reception control signal 50 so that data communications rates are not reduced as a result of the delay.

In addition, the controller 56 in this embodiment is also configured to generate the uplink transmission control signal 54 and the downlink reception control signal 50 (blocks 78, 80 in FIG. 5B) based on the determined downlink frame period(s) 40D in the TDD frame 38 (block 76 in FIG. 5B). This is so that the downlink receiver circuits 48, 49(1)-49(N) are activated to receive downlink TDD communications signals 16D during the downlink frame period(s) 40D in the TDD frame 38 when uplink TDD communication signals 16U are not being transmitted (process 84 in FIG. 5C). The downlink receiver circuits 48, 49(1)-49(N) receive the downlink reception control signal 50. This causes the downlink receiver circuits 48, 49(1)-49(N) to be activated to receive the downlink TDD communications signals 16D from the TDD base station 22 during downlink frame periods 40D in the TDD frame 38 (process 84 in FIG. 5C). This is so that the downlink receiver circuits 48, 49(1)-49(N) are activated to receive downlink TDD communications signals 16D during the downlink frame period(s) 40D in the TDD frame 38 (process 84 in FIG. 5C). During the downlink frame periods 40D in the TDD frame 38, the uplink transmission control signal 54 is configured to cause the uplink transmitter circuits 52, 53(1)-53(N) to be deactivated so that uplink TDD communications signals 16D are not transmitted during downlink frame periods 40D in the TDD frame 38 (process 84 in FIG. 5C).

Also note that the steps in FIG. 5A may performed continuously to continuously detect the uplink/downlink TDD frame 38 configuration. In this manner, if the uplink/downlink configuration of the TDD frame 38 provided by the TDD base station 22 changes, the changed uplink/downlink TDD frame 38 configuration can automatically be detected by the controller 56 to adjust synchronization of uplink TDD communications signals 16U with uplink frame periods 40U in the TDD frame 38. Similarly, the process in FIG. 5B may also be performed continuously to continuously generate the uplink transmission control signal 54 and the downlink reception control signal 50 based on the detected uplink/downlink TDD frame 38 in the process in FIG. 5A configuration to cause the uplink TDD communications signals 16U to be transmitted during uplink frame periods 40U in the TDD frame 38 in synchronization with downlink frame periods 40D in the TDD frame 38.

The embodiments disclosed herein for detecting an uplink/downlink TDD frame configuration of a TDD frame of TDD communications signals, and synchronizing TDD uplink communications transmissions based on the detected TDD frame configuration can be employed for different types of TDD communications signals and services. Non-limiting examples include WiMAX, Digital Enhanced Cordless Telecommunications (DECT) wireless telephony, and TD-code Division Multiple Access (CDMA) (TD-CDMA). Another example of such TDD communications services is TDD communications signals according to Long Term Evolution (LTE) protocol. LTE TDD communications signals are formatted according to a particular LTE TDD frame.

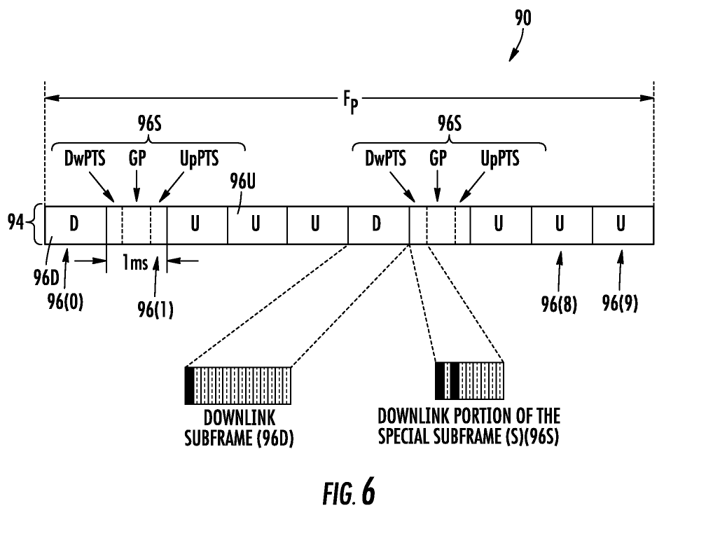

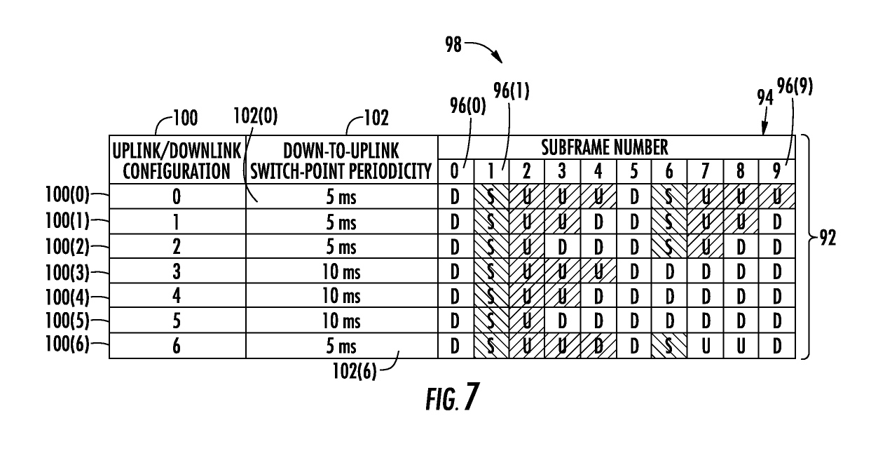

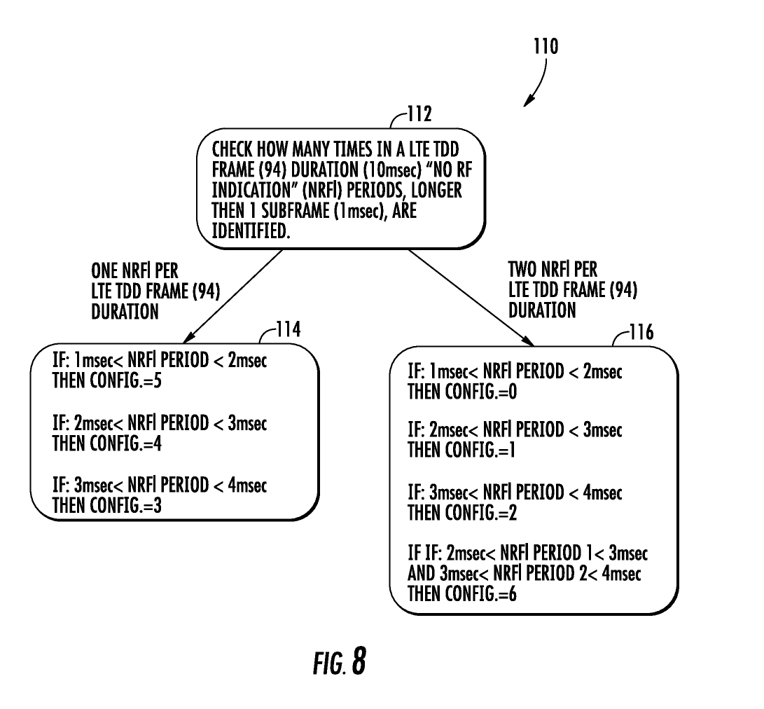

An example of a LTE TDD frame 90 is illustrated in FIG. 6 as an example according to one uplink/downlink LTE TDD frame configuration. Examples of different uplink/downlink LTE TDD frame configurations 92 are illustrated in FIG. 7, which are described in more detail below. Each of the uplink/downlink LTE TDD frame configurations 92 provide a different configuration of downlink frame periods and uplink frame periods. Thus, by detecting the particular uplink/downlink LTE TDD frame configuration being employed to control the transmission timing of received downlink TDD communications signal 16D, the controller 56 in the central unit 14 in FIG. 4 can be configured to synchronize transmission of the uplink TDD communications signals 16U based on the recognized timing patterns of the detected uplink/downlink LTE TDD frame configuration. In this manner, controller 56 can synchronize transmission of uplink TDD communications signals 16U to avoid or reduce data loss, as previously discussed above.

With reference to FIG. 6, one exemplary uplink/downlink LTE TDD frame configuration 100 is illustrated. FIG. 6 illustrates a LTE TDD frame 94. In this embodiment, the LTE TDD frame 94 is designated to be transmitted over a frame period Fp, which in this example is a ten (10) millisecond (ms) time period. The LTE TDD frame 94 is comprised of ten (10) LTE TDD sub-frames 96(0)-6(9) comprised of time slots or periods of one (1) ms in duration each. Each LTE TDD sub-frame 96(0)-6(9) is designated as a downlink LTE TDD sub-frame 96D, an uplink LTE TDD sub-frame 96U, or a LTE TDD special sub-frame 96S according to uplink/downlink LTE TDD frame configuration of the LTE TDD frame 94. The LTE TDD downlink sub-frames 96D designate downlink frame periods where downlink LTE TDD data is designated to be transmitted. The uplink LTE TDD sub-frames 96U designate uplink LTE TDD frame periods where uplink LTE TDD data is designated to be transmitted. The LTE TDD special sub-frame 96S designates a special frame period where a transition is designated to occur from a downlink LTE TDD frame period to an uplink LTE TDD frame period, or vice versa. The LTE TDD special sub-frame 96S is comprised of pilot timeslot (DwPTS), a guarded period (GP), and uplink pilot timeslot (UpPTS). The GP designates a frame period where no downlink or uplink TDD communications should occur as setup time for a transition downlink LTE TDD frame period to an uplink LTE TDD frame period in the LTE TDD frame 94, or vice versa.

FIG. 7 is a table 98 illustrating different uplink/downlink LTE TDD frame configurations 100 that can be detected to synchronize LTE TDD uplink communications transmissions from TDD communications unit, such as central unit 14 and remote units 24(1)-24(N) in FIG. 4, based on the detected LTE TDD frame configuration in a LTE TDD frame controlling the transmission timing of a downlink LTE TDD communications signal. In this regard, seven (7) unique uplink/downlink LTE TDD frame configurations 100(0)-100(6) are provided for an exemplary LTE TDD frame 94 in FIG. 7. The downlink-to-uplink switch-point periodicities 102(0)-102(6) are shown with each uplink/downlink LTE TDD frame configuration 100(0)-100(6), and are either five (5) ms or ten (10) ms. A downlink-to-uplink switch-point periodicity is the duration in which a switch should have occurred in the LTE TDD frame 94 for a given uplink/downlink LTE TDD frame configuration 100 from a downlink LTE TDD frame period or an uplink LTE TDD frame period.

With continuing reference to FIG. 7, note that for each different LTE TDD sub-frame 96(0)-96(9) for each of the uplink/downlink LTE TDD frame configurations 100(0)-100(6), knowledge of whether there is one (1) or two (2) LTE TDD sub-frames 96 in the LTE TDD frame 94 having no downlink communication (RF) indication (i.e., signal) (NRFI) designation can be used to distinguish between uplink/downlink LTE TDD frame configurations. As discussed above and illustrated in FIG. 6, each LTE TDD special sub-frame 96S includes a NRFI period less than one (1) millisecond ms. Thus, if the downlink TDD communications signal 16D monitored by the power detector 58 in FIG. 4 provides a NRFI of one LTE TDD sub-frame 96 per LTE TDD frame 94, the uplink/downlink LTE TDD frame configuration of the monitored downlink TDD communications signal 16D is known to be either uplink/downlink LTE TDD frame configuration 3 (100(3)), 4 (100(4)), or 5 (100(5)), as shown in FIG. 7. If the downlink TDD communications signal 16D monitored by the power detector 58 provides a NRFI of two LTE TDD sub-frames 96 per LTE TDD frame 94, the particular uplink/downlink LTE TDD frame configuration 100 of the monitored downlink TDD communications signal 16D is known to be either uplink/downlink LTE TDD frame configuration 0 (100(0)), 1 (100(1)), 2 (100(2)), or 6 (100(6)), as shown in FIG. 7. This is illustrated in FIG. 8, discussed below.

The table below illustrates the LTE TDD special sub-frame 96S configurations in one example for the LTE TDD frame 94. This table shows the duration of the fields (DwPTS, GP, and UpPTS) for the LTE TDD special sub-frame 96S. The duration of each field of the LTE TDD special sub-frame 96S is given in symbols. However, other LTE TDD special sub-frame 96S configurations may be provided in the TDD base station 22 by an operator based on the expected proportion between adjacent base stations.

TABLE 1
Exemplary LTE TDD Special (S) Sub-frame Configurations

| Special | Extended cyclic prefix length | | | Normal cyclic prefix length | | |
|---|---|---|---|---|---|---|
| subframe | in OFDM symbols | | | in OFDM symbols | | |
| configuration | DwPTS | GP | UpPTS | DwPTS | GP | UpPTS |
| 0 | 3 | 8 | 1 | 3 | 10 | 1 |
| 1 | 8 | 3 | | 9 | 4 | |
| 2 | 9 | 2 | | 10 | 3 | |
| 3 | 10 | 1 | | 11 | 2 | |
| 4 | 3 | 7 | 2 | 12 | 1 | |
| 5 | 8 | 2 | | 3 | 9 | 2 |
| 6 | 9 | 1 | | 9 | 3 | |
| 7 | — | — | — | 10 | 2 | |
| 8 | — | — | — | 11 | 1 | |

| | |
|---|---|
| Total = | Total = |
| 12 symbols | 14 symbols |
| Symbols = | Symbols = |
| 83.4 μsec | 71.4 μsec |

As one example, for the controller 56 to detect the NRFI period, the controller 56 may assume that the entire LTE TDD special sub-frame 96S, excluding a predefined period of time, is in the downlink LTE TDD frame period. For example, the predefined period of time for the TDD frame 94 may be 142 ms, which is 0.8 microseconds (its) less than the duration of two UpPTS signal in the LTE TDD special sub-frame 96S (see FIG. 7). This predefined period of time also allows enough time for the reception of the UpPTS signal while providing for the downlink TDD communications signal 16D to be fully transmitted in all LTE TDD special sub-frame 96S configurations. Thus, as another example, when the controller 56 creates a TDD timing frame pattern to synchronize transmission of the uplink TDD communications signal 16U (see FIG. 5 above), a time advance representing the time for the uplink frame period to transition to the downlink frame period in the uplink TDD communications signal 16U may be added to the TDD frame timing pattern. For example, for uplink/downlink TDD frame configuration 4 (100(4)) in FIG. 7, the TDD frame timing pattern may provide for 7.858 ms for the LTE TDD downlink frame period (i.e., seven (7) LTE TDD downlink sub-frames 96D sub-frames+one (1) LTE TDD special sub-frame 96S, minus 142 ms), and 2.142 ms for the LTE TDD downlink frame period (i.e., two (2) uplink LTE TDD sub-frames 96U plus 142 ms).

FIG. 8 is a flowchart 110 illustrating an exemplary process for detecting uplink/downlink LTE TDD frame configuration in a LTE TDD frame for the downlink TDD communications signal 16D that can be employed in block 74 in the exemplary process illustrated in FIG. 5A previously described above. The exemplary process in FIG. 8 can be employed to detect the uplink/downlink LTE TDD frame configuration 100 in a downlink TDD communications signal 16D according to the uplink/downlink LTE TDD frame configurations 100(0)-100(6) in FIG. 7 in particular. In this regard, the controller 56 in FIG. 4 can be configured to check how many times in a LTE TDD frame 94, a NRFI period of more than one (1) ms are identified (block 112). If one (1) NRFI exists in the LTE TDD frame 94, the uplink/downlink LTE TDD frame configuration of the monitored downlink TDD communications signal 16D is known to be either uplink/downlink LTE TDD frame configuration 3 (100(3)), 4 (100(4)), or 5 (100(5)), as shown in FIG. 7. If two (2) NRFI periods exist in the LTE TDD frame 94, the particular uplink/downlink LTE TDD frame configuration 100 of the monitored downlink TDD communication signal 16D is known to be either uplink/downlink LTE TDD frame configuration 0 (100(0)), 1 (100(1)), 2 (100(2)), or 6 (100(6)), as shown in FIG. 7.

With continuing reference to FIG. 8, block 114 provides further processing to determine the specific uplink/downlink LTE TDD frame configuration for scenarios of one (1) NRFI existing in the LTE TDD frame 94. In this regard, if NRFI period is greater than one (1) ms and less than two (2) ms, the particular uplink/downlink LTE TDD frame configuration 100 of the monitored downlink TDD communication signal 16D is known to be uplink/downlink LTE TDD frame configuration 5 (100(5)) (block 114). If the NRFI period is greater than two (2) ms and less than three (3) ms, the particular uplink/downlink LTE TDD frame configuration 100 of the monitored downlink TDD communication signal 16D is known to be uplink/downlink LTE TDD frame configuration 4 (100(4)) (block 114). If the NRFI period is greater than three (3) ms and less than four (4) ms, the particular uplink/downlink LTE TDD frame configuration 100 of the monitored downlink TDD communication signal 16D is known to be uplink/downlink LTE TDD frame configuration 3 (100(3)) (block 114).

With continuing reference to FIG. 8, block 116 provides further processing to determine the specific uplink/downlink LTE TDD frame configuration for scenarios of two (2) NRFI existing in the LTE TDD frame 94. In this regard, if NRFI period is greater than one (1) ms and less than two (2) ms, the particular uplink/downlink LTE TDD frame configuration 100 of the monitored downlink TDD communication signal 16D is known to be uplink/downlink LTE TDD frame configuration 0 (100(0)) (block 116). If the NRFI period is greater than two (2) ms and less than three (3) ms, the particular uplink/downlink LTE TDD frame configuration 100 of the monitored downlink TDD communication signal 16D is known to be uplink/downlink LTE TDD frame configuration 1 (100(1)) (block 116). If the NRFI period is greater than three (3) ms and less than four (4) ms, the particular uplink/downlink LTE TDD frame configuration 100 of the monitored downlink TDD communication signal 16D is known to be uplink/downlink LTE TDD frame configuration 2 (100(2)) (block 114). If one NRFI period is greater than two (2) ms and less than three (3) ms, and the second NRFI period is greater than three (3) ms and less than four (4) ms, the particular uplink/downlink LTE TDD frame configuration 100 of the monitored downlink TDD communication signal 16D is known to be uplink/downlink LTE TDD frame configuration 6 (100(6)) (block 116).

As previously discussed above with regard to FIGS. 4 and 5, the controller 56 can provide the processing in the process in FIG. 8 to detect the particular uplink/downlink LTE TDD frame configuration 100 for the downlink TDD communications signal 16D to synchronize transmission of the uplink TDD communications signal 16U. Thus, this process will not be re-described here.

The TDD communications units disclosed herein, including the TDD base station 22 and the central unit 14 in FIG. 1, may be capable of providing and supporting other communications services beyond TDD communication services. The TDD communications units may support other RF communications services, which may include, but are not limited to, US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink), medical telemetry frequencies, WLAN, WiMax, WiFi, Digital Subscriber Line (DSL), and LTE, etc.

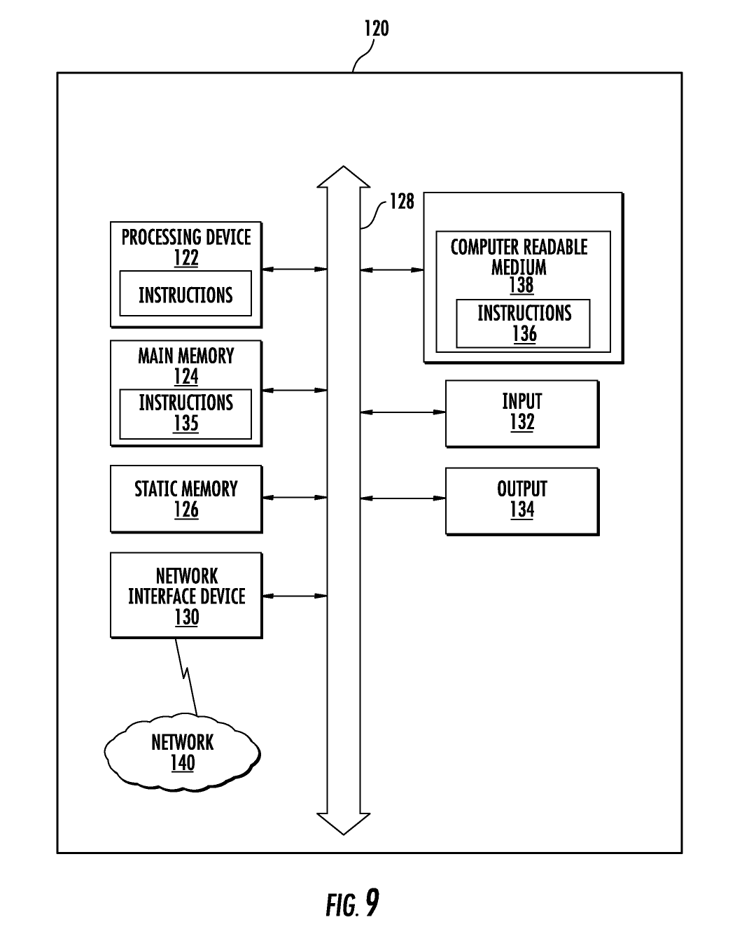

Any of the TDD communications units and components disclosed herein can include a computer system. In this regard, FIG. 9 is a schematic diagram representation of additional detail regarding an exemplary form of an exemplary computer system 120 that is configured to execute instructions from an exemplary computer-readable medium to perform synchronize transmission of uplink TDD communications signals over a communications medium with transmission of downlink TDD communications signals over the communications medium. The computer system 120 may be a controller. The computer system 120 can be included in any TDD communications unit.

In this regard, with reference to FIG. 9, the computer system 120 includes a set of instructions for causing the distributed antenna system component(s) to provide its designed functionality. The DAS component(s) may be connected (e.g., networked) to other machines in a LAN, an intranet, an extranet, or the Internet. The DAS component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The DAS component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server or a user's computer. The exemplary computer system 120 in this embodiment includes a processing device or processor 122, a main memory 124 (e.g., read-only memory (ROM), flash memory, dynamic random access memory (DRAM) such as synchronous DRAM (SDRAM), etc.), and a static memory 126 (e.g., flash memory, static random access memory (SRAM), etc.), which may communicate with each other via the data bus 128. Alternatively, the processing device 122 may be connected to the main memory 124 and/or static memory 126 directly or via some other connectivity means. The processing device 122 may be a controller, and the main memory 124 or static memory 126 may be any type of memory.

The processing device 122 represents one or more general-purpose processing devices such as a microprocessor, central processing unit, or the like. The processing device 122 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 132 is configured to execute processing logic in instructions 135 for performing the operations and steps discussed herein.

The computer system 120 may further include a network interface device 130, and an input 132 to receive input and selections to be communicated to the computer system 120 when executing instructions. The computer system 120 also may or may not include an output 134, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 120 may or may not include a data storage device that includes instructions 136 stored in a computer-readable medium 138. The instructions 135 may also reside, completely or at least partially, within the main memory 124 and/or within the processing device 122 during execution thereof by the computer system 120, the main memory 124 and the processing device 122 also constituting computer-readable medium. The instructions 136 may further be transmitted or received over a network 140 via the network interface device 130.

While the computer-readable medium 138 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the processing device and that cause the processing device to perform any one or more of the methodologies of the embodiments disclosed herein. The term “computer-readable medium” shall accordingly be taken to include, but not be limited to, solid-state memories, optical and magnetic medium, and carrier wave signals.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.).

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Unless otherwise expressly stated, it is in no way intended that any method set forth herein be construed as requiring that its steps be performed in a specific order.

Modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

We claim:

1. A time-division duplexed (TDD) communications unit, comprising:
a TDD communications signal interface configured to receive a downlink TDD communications signal and an uplink TDD communications signal over a communications medium;
an uplink transmitter circuit coupled to the TDD communications signal interface, the uplink transmitter circuit configured to transmit the uplink TDD communications signal over the communications medium during at least one uplink frame period of a TDD frame based on a received uplink transmission control signal;
a downlink receiver circuit coupled to the TDD communications signal interface, the downlink receiver circuit configured to be deactivated to not sample the downlink TDD communications signal during at least one uplink frame period of the TDD frame based on a received downlink reception control signal; and
a controller configured to:
detect an uplink/downlink TDD frame configuration of the TDD frame;
determine at least one uplink frame period in the TDD frame based on the detected uplink/downlink TDD frame configuration;
generate the uplink transmission control signal based on the determined at least one uplink frame period in the TDD frame; and
generate the downlink reception control signal based on the determined at least one uplink frame period in the TDD frame.

2. The TDD communications unit of claim 1, wherein: the uplink transmitter circuit is further configured to not transmit the uplink TDD communications signal over the communications medium during at least one downlink frame period of a TDD frame based on the received uplink transmission control signal;
the downlink receiver circuit further configured to be activated to receive the downlink TDD communications signal during the at least one downlink frame period of the TDD frame based on the received downlink reception control signal;
wherein the controller is further configured to:
determine at least one downlink frame period in the TDD frame based on the detected uplink/downlink TDD frame configuration;
generate the downlink reception control signal based on the determined at least one downlink frame period in the TDD frame; and
generate the uplink transmission control signal based on the determined at least one downlink frame period in the TDD frame.

3. The TDD communications unit of claim 1, further comprising a power detector comprising a power detector input coupled to the communications medium, the power detector configured to generate a power detector output representing detected power on the communications medium; and
wherein the controller is configured to detect the uplink/downlink TDD frame configuration of the TDD frame by being configured to detect the uplink/downlink TDD frame configuration of the TDD frame based on the power detector output received on the controller input from the power detector.

4. The TDD communications unit of claim 3, wherein the power detector is further configured to detect downlink power in a first subframe of the TDD frame on the communications medium.

5. The TDD communications unit of claim 1, wherein the downlink reception control signal is comprised of the uplink transmission control signal.

6. The TDD communications unit of claim 1, wherein the controller is further configured to continuously:
detect the uplink/downlink TDD frame configuration of the TDD frame; and
determine the at least one uplink frame period in the TDD frame based on the detected uplink/downlink TDD frame configuration.

7. The TDD communications unit of claim 1, wherein the controller is further configured to determine the at least one uplink frame period in the TDD frame, by being configured to detect at least one transition in the TDD frame.

8. The TDD communications unit of claim 7, wherein the controller is configured to determine the at least one uplink frame period in the TDD frame, by being configured to detect at least one transition from the at least one uplink frame period to at least one downlink frame period in the TDD frame.

9. The TDD communications unit of claim 7, wherein the controller is further configured to determine the at least one uplink frame period in the TDD frame, by being configured to detect at least one transition from at least one downlink frame period to the at least one uplink frame period in the TDD frame.

10. The TDD communications unit of claim 7, wherein the controller is configured to create a TDD frame timing pattern from the detected uplink/downlink TDD frame configuration and the detected at least one transition in the TDD frame.

11. The TDD communications unit of claim 10, wherein the controller is further configured to synchronize the TDD frame timing pattern with the TDD frame, to determine the at least one uplink frame period in the TDD frame.

12. The TDD communications unit of claim 1, wherein:
the TDD communications signal interface is configured to receive a downlink Long Term Evolution (LTE) TDD communications signal over the communications medium and an uplink Long Term Evolution (LTE) TDD communications signal over the communications medium;
wherein the TDD frame is comprised of a LTE TDD frame.

13. The TDD communications unit of claim 12, wherein the controller is further configured to detect the uplink/downlink TDD frame configuration of the LTE TDD frame based on a non-transmission duration on the communications medium being greater than one (1) LTE sub-frame in the LTE TDD frame.

14. The TDD communications unit of claim 13, wherein the controller is further configured to detect the uplink/downlink TDD frame configuration of the LTE TDD frame based on having one (1) non-transmission duration, if a number of the non-transmission duration in the LTE TDD frame is one (1).

15. The TDD communications unit of claim 13, wherein the controller is further configured to detect the uplink/downlink TDD frame configuration of the LTE TDD frame based on having two (2) non-transmission durations, if a number of the non-transmission duration in the LTD TDD frame is two (2).

16. The TDD communications unit of claim 1, wherein the TDD communications signal interface is configured to receive the downlink TDD communications signal from a TDD base station over a coaxial cable communications medium.

17. The TDD communications unit of claim 1, wherein the TDD communications signal interface is configured to receive a downlink TDD communications signal over the communications medium from a TDD base station.

18. A method for synchronizing time-division duplexed (TDD) downlink and uplink communications with a TDD communications unit, comprising:
receiving a downlink TDD communications signal having a TDD frame;
detecting an uplink/downlink TDD frame configuration of the TDD frame;
determining at least one uplink frame period in the TDD frame based on the detected uplink/downlink TDD frame configuration;
generating an uplink transmission control signal based on the determined at least one uplink frame period in the TDD frame;
generating a downlink reception control signal based on the determined at least one uplink frame period in the TDD frame;
transmitting an uplink TDD communications signal from an uplink transmitter circuit over a communications medium during the at least one uplink frame period in the TDD frame based on receiving the uplink transmission control signal; and
deactivating a downlink receiver circuit to not sample the downlink TDD communications signal during at least one uplink frame period of the TDD frame based on receiving the downlink reception control signal.

19. The method of claim 18, further comprising:
determining at least one downlink frame period in the TDD frame based on the detected uplink/downlink TDD frame configuration;
generating the downlink reception control signal based on the determined at least one downlink frame period in the TDD frame;
generating the uplink transmission control signal based on the determined at least one downlink frame period in the TDD frame;
not transmitting the uplink TDD communications signal from the uplink transmitter circuit over the communications medium during the at least one downlink frame period of a TDD frame based on the received uplink transmission control signal; and
receiving the downlink TDD communications signal in a downlink receiver circuit during the at least one on downlink frame period of the TDD frame based on the received downlink reception control signal.

20. The method of claim 18, further comprising:
detecting power on the communications medium in a power detector at a power detector input coupled to the communications medium; and
generating a power detector output from the power detector detecting power on the communications medium;
wherein detecting the uplink/downlink TDD frame configuration of the TDD frame comprises detecting the uplink/downlink TDD frame configuration of the TDD frame based on the power detector output received on the controller input from the power detector.

21. The method of claim 18, further comprising continuously:
receiving the downlink TDD communications signal having the TDD frame;
detecting the uplink/downlink TDD frame configuration of the TDD frame; and
determining the at least one uplink frame period in the TDD frame based on the detected uplink/downlink TDD frame configuration.

22. The method of claim 18, wherein determining the at least one uplink frame period in the TDD frame further comprises detecting at least one transition in the TDD frame.

23. The method of claim 18, further comprising creating a TDD frame timing pattern from the detected uplink/downlink TDD frame configuration and the detected at least one transition in the TDD frame, wherein determining the at least one uplink frame period in the TDD frame further comprises synchronizing the TDD frame timing pattern with the TDD frame.

24. A time-division domain (TDD) distributed antenna system, comprising:
a head-end unit, comprising:
a first TDD communications signal interface configured to receive a downlink TDD communications signal over a communications medium from a base station and distribute the downlink TDD communications signal to a plurality of remote units;
a second TDD communications interface configured to receive an uplink TDD communications signal from the plurality of remote units and distribute the received uplink TDD communications signal to the base station;
an uplink transmitter circuit coupled to the first TDD communications signal interface, the uplink transmitter circuit configured to transmit the received uplink TDD communications signal from at least one distributed antenna system communications medium communicatively coupling a plurality of remote units to the head-end unit, over the communications medium to the base station during at least one uplink frame period of a TDD frame based on a received uplink transmission control signal;
a downlink receiver circuit coupled to the first TDD communications signal interface, the downlink receiver circuit configured to be deactivated to not sample the downlink TDD communications signal during at least one uplink frame period of the TDD frame based on a received downlink reception control signal; and
a controller configured to:
detect an uplink/downlink TDD frame configuration of the TDD frame;
determine at least one uplink frame period in the TDD frame based on the detected uplink/downlink TDD frame configuration;
generate the uplink transmission control signal based on the determined at least one uplink frame period in the TDD frame; and
generate the downlink reception control signal based on the determined at least one uplink frame period in the TDD frame;
each of the plurality of remote units comprising:
at least one antenna configured to receive the uplink TDD communications signal from at least one TDD client device;
an uplink transmitter circuit configured to transmit the uplink TDD communications signal over the at least one distributed antenna system communications medium to the head-end unit during at least one uplink frame period of a TDD frame, based on a received uplink transmission control signal from the head-end unit;
a downlink receiver circuit configured to be deactivated to not sample the downlink TDD communications signal received from the head-end unit over the at least one distributed antenna system communications medium during the at least one uplink frame period of the TDD frame, based on a received downlink reception control signal from the head-end unit.
